(19) United States
(12) Patent Application Publication
(10) Pub. No.: US 2010/0055247 A1
(43) Pub. Date: Mar. 4, 2010

(54) Nutritional Compositions for Athletes

(76) Inventor: Salvatore J. Tirrito, Tucson, AZ (US)

Correspondence Address: QUARLES & BRADY LLP, ONE SOUTH CHURCH AVENUE, SUITE 1700, TUCSON, AZ, 85701-1621, US

(21) Appl. No.: 12/201,849

(22) Filed: Aug. 29, 2008

(51) Int. Cl. A23L 1/305; A23L 1/302; A23L 1/05

(52) U.S. Cl. 426/72; 426/656; 426/655; 426/573

(57) ABSTRACT

Nutritional compositions in a dry powder, bar, and gel form including a 2:1 ratio of maltodextrin to fructose and one or more proteins. Further compositions include maltodextrin, fructose, whey protein, and a standardized amount of an extract selected from the group consisting of green tea, pomegranate, and mangosteen. Having the carbohydrates and one or more proteins present in a 12:1 ratio also has been found to be desirable. The addition of select vitamins and electrolytes further aid in carbohydrate metabolism and general hydration.

### BACKGROUND OF THE INVENTION

The invention relates to nutritional compositions for consumption by persons and especially athletes that include at least fructose, maltodextrin and a protein.

Much research has been performed on athletes to determine the roles that hydration and carbohydrates play in improving performance. This research has led to the development of a variety of sports drinks, bars, and gels that contain carbohydrates and electrolytes. When consumed during exercise, carbohydrates are transported from the blood into the muscle where they then can be converted into energy.

However, when high levels of carbohydrates are consumed during exercise, intake becomes rate limiting because carbohydrates do not get absorbed through the stomach rapidly enough to replenish what is consumed. Thus, protein has been added to carbohydrates in many sports compositions in order to enhance the uptake of carbohydrates through increased insulin production.

Many nutritional compositions have been created to try to optimize energy production, rehydration, and endurance. For example, U.S. Pat. No. 6,207,638 disclosed that when protein is added to carbohydrate in a 4 to 1 ratio, it provides increased insulin stimulation and enhances the synthesis of muscle glycogen. U.S. Pat. No. 4,853,237 discloses a fitness drink powder containing glucose polymer, various salts and fruit acid. U.S. Pat. No. 5,032,411 disclosed a hypotonic beverage with essential electrolytes, minerals and carbohydrates. Because the beverage composition is hypotonic, the stomach empties very rapidly and the composition can produce a beneficial physiologic response. U.S. Pat. No. 6,039,987 disclosed a composition to prevent dehydration and prevent cramps which contains electrolytes, carbohydrates and quinine.

However, finding compositions that are desirable and optimal for consumption during exercise has proven elusive for a number of reasons, including taste considerations and stomach tolerance. Accordingly, the need for research and development in this area continues.

### SUMMARY OF THE INVENTION

One aspect of the invention includes a 2 to 1 ratio of maltodextrin to fructose that allows both simple sugars and complex carbohydrates to be available to the user such that relatively quick boost of energy, as well as a longer lasting energy source, are made available.

In another aspect of the invention, the compositions include a 12 to 1 ratio of carbohydrates to protein. This ratio has been found to be less likely to upset a user's stomach then compositions including a greater amount of protein. Preferably, the protein present in the composition includes ultra-fine whey protein to maximize absorption in the stomach and homogeneity of mixing with a liquid.

In another aspect of the invention, standardized amounts of natural pomegranate, mangosteen, and green tea extracts are included. In addition to antioxidant capabilities, pomegranate, mangosteen, and green tea flavorings have been found to enhance composition taste. This is not a trivial consideration, because some sports compositions inhibit consumption due to poor flavor. Moreover, some flavorings and/or combination of ingredients can even illicit nausea in some users.

In another aspect of the invention, electrolytes and vitamins are added to the compositions to assist in hydration and carbohydrate metabolism.

Still further aspects of the invention are detailed below.

### DETAILED DESCRIPTION OF THE INVENTION

Compositions of the invention are based on the discovery that by providing a nutritional composition that contains at least two carbohydrates including a 2:1 ratio of maltodextrin to fructose and a protein, the energy produced from the carbohydrates is optimized while insulin production assists in better carbohydrate absorption. This optimization relates to both simple sugars and complex carbohydrates being available to the user such that both a relatively quick boost of energy and a longer lasting energy source are made available.

A second discovery is that a carbohydrate to protein ratio in the range of 12:1 increases glucose uptake during exercise by stimulating insulin while not interfering with gastric emptying which would impact fluid and carbohydrate absorption during exercise.

To the inventor's knowledge, no other sports drink or dry powder composition contains standardized extracts of green tea, mangosteen, or pomegranate, thereby giving an athlete the antioxidant and other benefits that researchers have shown to be associated therewith. Furthermore, the inclusion of these standardized extracts in compositions of the invention have been found by the inventor to not increase the chances of stomach upset, even when consumed during rigorous or prolonged activity.

Another benefit discovered by the inventor is that green tea, mangosteen, or pomegranate flavoring (as opposed to a standardized extract containing actual green tea, mangosteen, or pomegranate components) produce a “light” and very palatable flavor in combination with the carbohydrates and protein(s) of the compositions. This encourages consumption to maintain energy and hydration levels, especially during intense exercise or activities that can increase the possibility of gastrointestinal upset, dehydration, and other serious consequences.

The nutritional compositions of the preferred and alternate embodiments of the present invention are in a dry form, which is made into a liquid drink, a bar or a gel. The nutritional compositions are used to enhance performance and extend endurance during exercise and aid in the prevention of free radicals build-up after exercise.

A preferred nutritional composition of the invention is in a dry powder form. The dry nutritional composition includes at least two carbohydrates including maltodextrin and fructose in a ratio of 2:1 and at least one protein in a ratio of 12:1 to the carbohydrates.

Preferably, the protein includes whey protein, which may take the form of whey protein concentrate or whey protein isolate. Preferably, ultra fine whey protein, i.e., whey protein that has a particle size in the range of 0.5 to 10 μm, is especially preferred.

The dry nutritional composition may further include vitamins. Vitamins B6 and B12, Vitamin C (in the form of ascorbic acid), Vitamin D, and Vitamin E are especially preferred. In addition, Folic Acid and Riboflavin are desirable additions.

The dry nutritional composition also may include one or more electrolyte ions, including sodium, potassium, magnesium, calcium, and chloride.

Other component constituents of the nutritional composition in dry and liquid form include a natural extract component for delivery of an antioxidant and other effects and flavorings for improved taste. The natural extract component and flavoring is selected from the group consisting of green tea, pomegranate, and mangosteen.

Especially preferred is including a standardized amount of a green tea, pomegranate, or mangosteen extract. Tea polyphenols in particular can lead to stomach upset, especially when consumed in large amounts or on an empty stomach. The inventor has empirically found that 50 mg per serving of a green tea, pomegranate, or mangosteen extract does not cause increased stomach upset.

Typically, the dry nutritional composition, as shown in Tables A-C below, is mixed with liquid (preferably water), such that approximately 36 grams of the dry nutritional composition is dissolved in 16-24 ounces of a water in order to provide a nutritional drink composition. Tables A-C show the dry weight in grams or international units of the constituent compounds of the nutritional composition prior to the dilution using water.

TABLE A
Serving Size: Per 1 (approx 35.6 g)

| Amount | | |
|---|---|---|
| Per Serving | | |
| Vitamin C (as ascorbic acid) | 50 | mg |
| Vitamin D | 12.5 | IU |
| Vitamin E, natural | 12.5 | IU |
| Riboflavin | 0.13 | mg |
| Vitamin B6 | 0.25 | mg |
| Folate | 12.5 | mcg |
| Vitamin B12 | 0.13 | mcg |
| Calcium (as AAC) | 50 | mg |
| Magnesium (as AAC) | 75 | mg |
| Chloride (as sodium chloride) | 154.5 | mg |
| Sodium (as sodium chloride) | 100 | mg |
| Potassium (as AAC) | 75 | mg |
| Maltodextrin | 20000 | mg |
| Whey Protein | 2500 | mg |
| Green Tea Extract (50% caffeine) | 50 | mg |

| | |
|---|---|
| Other ingredients: | Fructose (10 g), |
| | natural lemon and |
| | green tea flavors, |
| | citric acid. |

TABLE B
Serving Size: Per 1 (approx 36.4 g)

| Amount | | |
|---|---|---|
| Per Serving | | |
| Vitamin C (as ascorbic acid) | 50 | mg |
| Vitamin D | 12.5 | IU |
| Vitamin E, natural | 12.5 | IU |
| Riboflavin | 0.13 | mg |
| Vitamin B6 | 0.25 | mg |
| Folate | 12.5 | mcg |
| Vitamin B12 | 0.13 | mcg |
| Calcium (as AAC) | 50 | mg |
| Magnesium (as AAC) | 75 | mg |
| Chloride (as sodium chloride) | 154.5 | mg |
| Sodium (as sodium chloride) | 100 | mg |
| Potassium (as AAC) | 75 | mg |
| Maltodextrin | 20000 | mg |
| Whey Protein | 2500 | mg |
| Pomegranate Extract | 50 | mg |

| | |
|---|---|
| Other ingredients: | Fructose (10 g), |
| | natural strawberry and |
| | pomegranate flavors, |
| | citric acid, beet root. |

TABLE C
Serving Size: Per 1 (approx 36.6 g)

| Amount | | |
|---|---|---|
| Per Serving | | |
| Vitamin C (as ascorbic acid) | 50 | mg |
| Vitamin D | 12.5 | IU |
| Vitamin E, natural | 12.5 | IU |
| Riboflavin | 0.13 | mg |
| Vitamin B6 | 0.25 | mg |
| Folate | 12.5 | mcg |
| Vitamin B12 | 0.13 | mcg |
| Calcium (as AAC) | 50 | mg |
| Magnesium (as | 75 | mg |
| AAC) | | |
| Chloride (as sodium chloride) | 154.5 | mg |
| Sodium (as sodium chloride) | 100 | mg |
| Potassium (as AAC) | 75 | mg |
| Maltodextrin | 20000 | mg |
| Whey Protein | 2500 | mg |
| Mangosteen Extract | 50 | mg |

| | |
|---|---|
| Other ingredients: | Fructose (10 g), |
| | natural orange |
| | and mangosteen |
| | flavors, orange juice |
| | powder, and citric acid. |

Other embodiments for the nutritional composition include energy bars where a binder is included and is in the form of chocolate, oats, wheat, peanut butter, semi-dried fruits, grains and combinations thereof.

Moreover a gel composition may be utilized, where the dry power composition is mixed with a viscous liquid “gel base” (such as a syrup) until a gel consistency is formed.

Testing has been conducted to obtain feedback on the benefits of the nutritional drink composition of the present invention. Among other feedback, test participants have particularly noted the mild taste, lack of bloating/other gastrointestinal issues, and that the balance of the fructose and maltodextrin sugars to protein(s) has left them feeling better both during exercise and recovery.

Although the invention has been described with reference to various compositions, it will be appreciated that various changes and modifications may be made without departing from the invention. The foregoing examples are provided to better illustrate the invention and are not intended to limit the scope of the invention.

What is claimed is:

1. A nutritional composition in a dry powder form, comprising at least two carbohydrates, including a 2:1 ratio of maltodextrin to fructose, and a protein.

2. The nutritional composition according to claim 1, wherein said carbohydrates and one or more protein are present in a 12:1 ratio.

2. The nutritional composition according to claim 1, further including citric acid.

3. The nutritional composition according to claim 1, wherein said protein comprises whey protein.

4. The nutritional composition according to claim 3, wherein said whey protein is ultrafine whey protein.

5. The nutritional composition according to claim 1, further including an extract selected from the group consisting of green tea, pomegranate, and mangosteen.

6. The nutritional composition according to claim 5, wherein said extract of green tea, pomegranate, and mangosteen are present in a standardized amount.

7. The nutritional composition according to claim 6, wherein said standardized amount is 50 mg per serving.

8. The nutritional composition according to claim 1, further including one or more electrolytes.

9. The nutritional composition according to claim 1, further including one or more vitamins.

10. A nutritional composition in a dry powder form, consisting essentially of maltodextrin, fructose, whey protein, and a standardized amount of an extract selected from the group consisting of green tea, pomegranate, and mangosteen.

11. The nutritional composition according to claim 10, wherein said carbohydrate and whey protein are present in a 12:1 ratio.

12. The nutritional composition according to claim 10, wherein the ratio of maltodextrin to fructose is 2:1.

13. The nutritional composition according to claim 10, wherein said whey protein is ultrafine whey protein.

14. The nutritional composition according to claim 10, wherein said standardized amount is 50 mg per serving.

15. A nutritional composition in a bar form comprising a 2:1 ratio of maltodextrin to fructose, a protein, and a binder.

16. The nutritional composition according to claim 15, further including citric acid.

17. The nutritional composition according to claim 15, wherein said protein comprises whey protein.

18. The nutritional composition according to claim 17, wherein said whey protein is ultrafine whey protein.

19. The nutritional composition according to claim 15, further including a standardized amount of an extract selected from the group consisting of green tea, pomegranate, and mangosteen.

20. The nutritional composition according to claim 19, wherein said standardized amount is 50 mg per serving.

21. A nutritional composition in a gel form comprising a 2:1 ratio of maltodextrin to fructose, one or more proteins, and a gel base.

22. The nutritional composition according to claim 21, further including citric acid.

23. The nutritional composition according to claim 21, wherein said protein comprises whey protein.

24. The nutritional composition according to claim 23, wherein said whey protein is ultrafine whey protein.

25. The nutritional composition according to claim 21, further including a standardized amount of an extract selected from the group consisting of green tea, pomegranate, and mangosteen.

26. The nutritional composition according to claim 25, wherein said standardized amount is 50 mg per serving.
